(19) United States
(12) Patent Application Publication
(10) Pub. No.: US 2010/0203463 A1
(43) Pub. Date: Aug. 12, 2010

(54) SELF-LIGATING ORTHODONTIC BRACKET

(75) Inventors: Stephen M. Huff, Escondido, CA (US); Douglas D. Crimaldi, San Marcos, CA (US); Aaron D. Costello, Chula Vista, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Ortho Organizers, Inc., Carlsbad, CA (US)

(21) Appl. No.: 12/236,399

(22) Filed: Feb. 6, 2009

(51) Int. Cl. A61C 7/28

(52) U.S. Cl. 433/10

(57) ABSTRACT

The self-ligating orthodontic bracket includes a bracket body with an archwire slot, a pair of spaced apart mounting arms having first and second mounting slots, and a mounting pin permanently mounted in the first and second mounting slots. A closure member is slidably mounted to the body of the bracket and movable between and reversibly latchable in at least one of a closed position in which at least a portion of the archwire slot is covered and an open position in which the archwire slot is uncovered. The closure member may also be slidably and rotatably mounted to the body of the bracket.

### BACKGROUND OF THE INVENTION

This invention relates generally to brackets used in orthodontic treatment, and more particularly concerns self-ligating orthodontic brackets having an archwire slot, and having a latch that can slide and rotate to releasably retain an archwire in the archwire slot.

Orthodontic appliances, such as brackets, buccal tubes and the like are typically applied to teeth by adhering the appliances to the surface of the teeth to orient the teeth by the application of forces on the teeth by such orthodontic appliances. Such appliances typically include an archwire slot portion for receiving an archwire and ligature elastic bands to provide corrective forces to straighten and reposition the teeth. The orthodontic appliances typically include a base portion adapted generally to conform to the shape of the teeth to which they are applied, and elastic or wire ligature ties are used to hold the archwire in the archwire slot during initial and intermediate stages of treatment. However, installation and reinstallation of archwires in orthodontic brackets can be time consuming, and ligatures can become stained and may retain plaque and food debris, which can in turn result in tooth decay or infection.

A variety of self-ligating brackets have been proposed to seat and retain an archwire in an archwire slot, in order to overcome problems associated with the use of ligatures. One conventional self-ligating orthodontic bracket includes a pair of cavities extending along an archwire slot, one of the cavities extending along an occlusal side of the archwire slot and the other of the cavities extending along a gingival side of the archwire slot, with a wire latch received in the cavities for retaining an archwire in the archwire slot. Another type of self-ligating orthodontic bracket has a rotatable cover plate that pivotally moves between an archwire slot-open position and an archwire slot-closed position.

Typically, such self-ligating orthodontic brackets provide an outside cover forming only an outside wall over an archwire slot, and are either passive or active. An active self-ligating orthodontic bracket is one in which the self-ligating mechanism applies pressure to an archwire, such as in order to urge a surface of the archwire to be coplanar with a surface of the archwire slot. This is typically done by having the ligature mechanism push down on the archwire to make the archwire rest flat on a surface of the archwire slot, such as the bottom of the archwire slot. During orthodontic treatment, it is typically desirable to have a passive self-ligating orthodontic bracket exerting little or no pressure on the archwire in the early stages of treatment, when smaller archwires are used, and to have pressure applied actively to the archwire in later stages of treatment, when larger wires are used.

It would be desirable to provide a self-ligating orthodontic bracket with a closure member that is slidably and rotatably moveable between open and closed positions, and having a latching mechanism configured to promote hygiene and more consistent function throughout treatment. It would also be desirable to provide a self-ligating orthodontic bracket with a closure member that can reversibly latch in an open position to eliminate premature closure during archwire changes. It would also be desirable to provide a self-ligating orthodontic bracket with a closure member that forms a top cover side and at least a portion of a side wall of an archwire slot, with the a top cover side and side wall side portions extending in two substantially orthogonal directions to allow containment of the archwire from two substantially orthogonal directions, instead of only one direction, and to allow the slot width to be variable, so that the self-ligating orthodontic bracket can be either passive to active. The present invention meets these and other needs.

### SUMMARY OF THE INVENTION

Briefly, and in general terms, the present invention provides for a self-ligating orthodontic bracket with a sliding closure member mounted to the body of the bracket with an internal reversibly latching mechanism that is shielded from exposure to plaque, food, bacteria, and the like. The sliding closure member can slide in a gingival-occlusal direction between closed and open positions, can be reversibly latched in at least one of the closed position and the open position, and can rotate outwardly further when the sliding closure member is in the open position. Furthermore, the sliding closure member forms two of the four walls defining the archwire slot of the bracket body. The self-ligating orthodontic bracket sliding closure member and locking mechanism can be applied to any typical 5×5 bracket labially or lingually and can be applied to any typical 1st, 2nd, or 3rd molar buccal tube, labially or lingually.

Accordingly, the present invention provides for a self-ligating orthodontic bracket with a body having a bottom side including a base defined on the bottom side configured to be joined to an orthodontic band or configured to be adhered to a tooth surface, and a top side with an archwire slot. The bracket body includes a pair of spaced apart mounting arms having first and second mounting slots, and a mounting pin that forms an integral part of the latching mechanism, and that is permanently mounted in the first and second mounting slots of the mounting arms. The mounting pin is typically substantially cylindrical, but may have a varying or non-constant diameter, such as a stepped cylindrical configuration or a tapered configuration, for example. A sliding closure member is slidably mounted to the body of the bracket. The sliding closure member provides a top cover side and at least a portion of a side wall of an archwire slot, with the a top cover side and side wall side portions extending in two substantially orthogonal directions, to allow containment of the archwire from two substantially orthogonal directions, instead of only one direction, and to allow the slot width to be variable, so that the self-ligating orthodontic bracket can be either passive to active. In one presently preferred aspect, the sliding closure member is slidably movable occlusally and gingivally between a closed position covering at least a portion of the archwire slot and an open position in which the archwire slot is uncovered. In a presently preferred aspect, the sliding closure member is slidably and rotatably mounted to the body of the bracket.

The sliding closure member includes a main body portion having an interior slot that forms another integral part of the latching mechanism. The main body portion includes a middle connector portion, an upper arm extending in a first direction from the middle connector portion, an upper cover portion extending from the middle connector portion in a second direction opposing the first direction, and a lower arm extending from the middle connector portion adjacent to the upper arm. In a presently preferred aspect, the main body portion has a configuration allowing at least one of the upper and lower arms to flex with respect to the other and the middle connector portion, such that the shape of the interior slot can change as the sliding closure member is moved from one position to another, to reversibly latch the sliding closure member as desired. The upper arm and lower arm also have interior surfaces defining an interior shape of the interior slot therebetween, such that at least a portion of the slot has a width that is slightly smaller than a diameter of the mounting pin, and at least one other portion of the slot having a width larger than the diameter of the mounting pin and configured to receive the mounting pin. In one form, a slit may be formed between the upper and lower arms at the occlusal end of the upper arm and lower arms, or a slit may be formed in a desired location along the lower arm, to allow at least one of the upper and lower arms to flex with respect to the other and the middle connector portion. Alternatively, the sliding closure member may be formed without a slit, and of a material of sufficient flexibility and with at least one of the upper and lower arms being dimensioned of an appropriate thickness such that at least one the upper and lower arms can flex with respect to the other and the middle connector portion.

In one embodiment, the bracket body includes a plurality of tiewings, such as a pair of spaced apart tiewings, and the archwire slot includes gingival and occlusal side walls, and a planar surface forming a base wall opposing the bonding base and extending between the spaced apart tie wings and mounting arms, with the archwire slot being recessed from the tiewings. The bracket body includes a middle post portion between the mounting arms and having a planar surface forming an extension of the base wall of the archwire slot between first and second openings defined in the body by first and second recesses on either side of the middle post portion. In another aspect, the archwire slot is recessed from the mounting arms. In one presently preferred aspect, the lower arm of the sliding closure member includes a generally rectangular middle notch portion between first and second portions of the lower arm of the sliding closure member, with the generally rectangular middle notch portion opening into the slit of the sliding closure member, allowing the lower arm of the sliding closure member to rotate over the middle post portion and allowing the first and second portions of the lower arm of the sliding closure member to rotate into the openings defined by the recesses on either side of the middle post portion when the sliding closure member is in the open position, to rotate the upper cover portion of the sliding closure member away from the archwire slot.

In one form of the sliding closure member, the upper arm and lower arm of the sliding closure member have interior surfaces defining a generally double-ended keyhole slot having a middle narrow neck portion with a width slightly smaller than a diameter of the mounting pin, a generally rounded gingival portion adjacent to the middle connector portion having a width larger than a diameter of the mounting pin, and a generally rounded occlusal portion having a width larger than a diameter of the mounting pin, with a slit formed in the lower arm adjacent to the generally rounded occlusal portion. Alternatively, a slit may be formed in a desired location along the lower arm, to allow at least one of the upper and lower arms to flex with respect to the other and the middle connector portion, or the sliding closure member may be formed without a slit, and of a material of sufficient flexibility and with at least one of the upper and lower arms being dimensioned of an appropriate thickness such that at least one the upper and lower arms can flex with respect to the other and the middle connector portion.

In another form of the sliding closure member, the upper arm and lower arm have interior surfaces defining a generally teardrop shaped keyhole slot having a generally rounded occlusal portion wider than a diameter of the mounting pin adjacent to and connecting with a slit at the occlusal end of the upper and lower arms, the generally rounded occlusal portion tapering smoothly to a narrow neck portion and a narrower generally rounded gingival end with a width slightly smaller than a diameter of the mounting pin to receive the mounting pin. In one presently preferred aspect, the self-ligating orthodontic bracket is an active self-ligating bracket. Alternatively, a slit may be formed in a desired location along the lower arm, to allow at least one of the upper and lower arms to flex with respect to the other and the middle connector portion, or the sliding closure member may be formed without a slit, and of a material of sufficient flexibility and with at least one of the upper and lower arms being dimensioned of an appropriate thickness such that at least one the upper and lower arms can flex with respect to the other and the middle connector portion.

In another embodiment, the self-ligating orthodontic bracket can be a molar buccal tube bracket including an archwire slot and mounting arms, and optionally including an auxiliary tube. The archwire slot is recessed from the mounting arms, and includes gingival and occlusal side walls, and a planar surface forming a base wall opposing the base and extending between a gingival side wall and an occlusal side wall, and the mounting arms. In another aspect, the self-ligating orthodontic bracket also can optionally include a hook.

These and other aspects and advantages of the invention will become apparent from the following detailed description, and the accompanying drawings which illustrate, by way of example, the features of the invention.

### BRIEF DESCRIPTION OF THE DRAWINGS

FIG. 1 is a perspective view of a first embodiment of a self-ligating orthodontic bracket according to the present invention.

FIG. 2 is a top plan view of the self-ligating orthodontic bracket of FIG. 1.

FIG. 3 is a cross-sectional view of the self-ligating orthodontic bracket taken along line 3-3 of FIG. 2, showing the sliding closure member in a closed position with the archwire slot covered by the sliding closure member.

FIG. 4 is a cross-sectional view of the self-ligating orthodontic bracket taken along line 4-4 of FIG. 2.

FIG. 5 is an exploded view of the self-ligating orthodontic bracket of FIG. 1.

FIG. 6A is a cross-sectional view of the self-ligating orthodontic bracket similar to FIG. 3, showing the sliding closure member in an open position with the archwire slot uncovered.

FIG. 6B is a cross-sectional view of the self-ligating orthodontic bracket similar to FIG. 6B, showing the sliding closure member with the archwire slot cover rotated outwardly from the open position.

FIG. 7A is a bottom plan view of the sliding closure member of the self-ligating orthodontic bracket of FIG. 1.

FIG. 7B is a cross-sectional view of the sliding closure member of the self-ligating orthodontic bracket taken along line 7B-7B of FIG. 7A.

FIG. 8 is a perspective view of a second embodiment of the self-ligating orthodontic bracket of FIG. 1, as applied to a molar buccal tube bracket, according to the present invention.

FIG. 9 is a top plan view of the self-ligating orthodontic bracket of FIG. 8.

FIG. 10 is a cross-sectional view of the self-ligating orthodontic bracket taken along line 10-10 of FIG. 9, showing the sliding closure member in a closed position with the archwire slot covered by the sliding closure member.

FIG. 11 is a cross-sectional view of the self-ligating orthodontic bracket taken along line 11-11 of FIG. 9.

FIG. 12 is an exploded view of the self-ligating orthodontic bracket of FIG. 8.

FIG. 13 is a cross-sectional view of the self-ligating orthodontic bracket similar to FIG. 10, showing the sliding closure member in an open position with the archwire slot uncovered.

FIG. 14 is a side perspective view of a first alternate sliding closure member that may be substituted for the sliding closure member of the first and second embodiments.

FIG. 15 is a side perspective view of a second alternate sliding closure member that may be substituted for the sliding closure member of the first and second embodiments.

FIG. 16 is a side perspective view of a third alternate sliding closure member that may be substituted for the sliding closure member of the first and second embodiments.

FIG. 17 is a side perspective view of a fourth alternate sliding closure member that may be substituted for the sliding closure member of the first and second embodiments.

FIG. 18 is a side perspective view of a fifth alternate sliding closure member that may be substituted for the sliding closure member of the first and second embodiments.

### DETAILED DESCRIPTION OF THE PREFERRED EMBODIMENTS

While a variety of self-ligating brackets have been designed to seat and retain an archwire in an archwire slot of an orthodontic bracket, in order to overcome problems associated with the use of ligatures, such self-ligating brackets typically provide an archwire slot cover that forms only one side of the archwire slot, is only either passive or active, and only either slidable or rotatable.

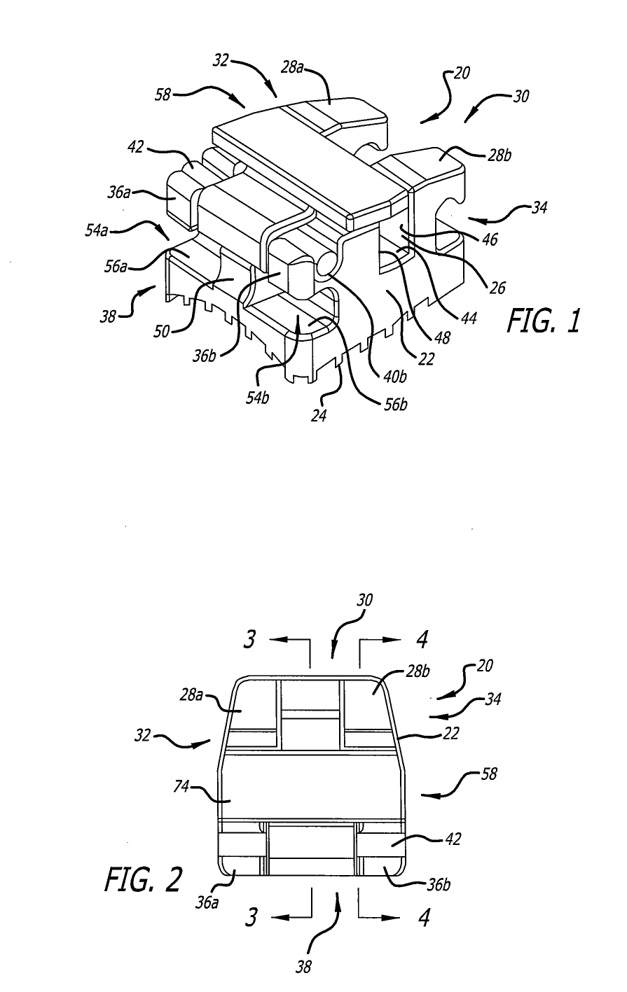

Referring to FIGS. 1-7B, in a first embodiment of the present invention, the self-ligating orthodontic bracket 20 includes a molded unitary body 22 having a base 24 that is defined on the bottom side configured to be joined to an orthodontic band or configured to be adhered to a tooth surface (not shown). The bonding base is currently preferably formed to have a bottom rectangular grid forming a plurality of rectangular pockets. The unitary body can be formed of metal, metal alloy, ceramic, plastic, polymer, composite, or other similar materials, for example. The body also is also preferably formed to include an archwire slot 26 configured to receive an archwire (not shown). The body may also include a plurality of tiewings, such as a pair of spaced apart tiewings 28a, 28b, on the gingival 30 mesial 32 and distal 34 sides of the body.

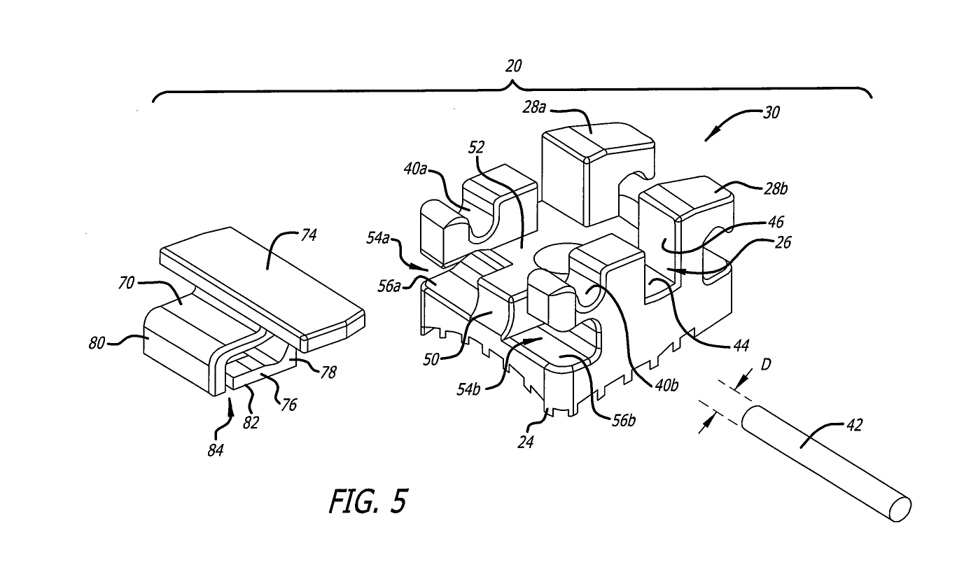

Referring to FIGS. 1 and 5, in a presently preferred aspect, the bracket body includes pair of spaced apart mounting arms 36a, 36b, on the occlusal 38 mesial and distal sides of the body, including first and second slots 40a, 40b, in which a mounting pin 42, typically having a substantially cylindrical uniform, constant diameter along the length of the mounting pin, is permanently mounted. Alternatively, the mounting pin may have a varying or non-constant diameter, such as a stepped cylindrical configuration or a tapered configuration, for example. The mounting pin forms an integral part of the reversibly latching mechanism, as will be explained further below. The archwire slot is typically recessed from the tiewings and mounting arms, and includes a labial planar surface forming a base wall 44 opposing the bonding base, and extending between the spaced apart tie wings and mounting arms, a gingival side wall 46, and an occlusal side wall 48.

Referring to FIG. 5, the body also typically includes a middle post portion 50 positioned between and spaced apart from the mounting arms, with a planar surface 52 forming an extension of the base wall of the archwire slot between openings 54a and 54b defined in the body by recesses 56a and 56b on either side of the middle post portion, as will be explained further hereinbelow.

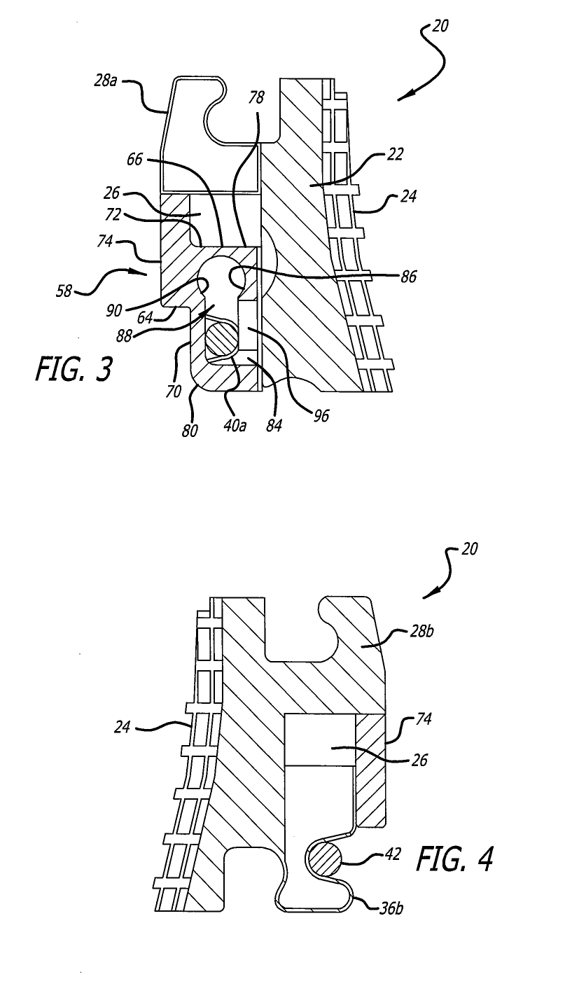

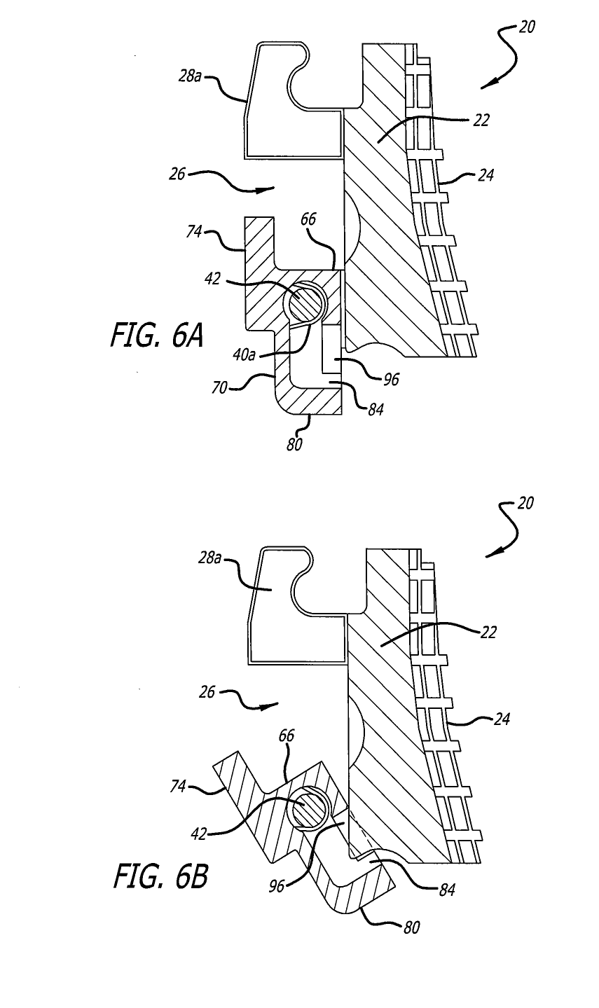

A sliding closure member 58 is slidably and rotatably mounted to the body of the bracket, and is slidably movable in the occlusal/gingival direction between a closed position covering the archwire slot, as shown in FIGS. 1-4, and an open position in which the archwire slot is uncovered, as shown in FIG. 6A. The sliding closure member can be reversibly latched in at least one of the open and closed positions with a reversibly latching mechanism, which will be described below. Referring to FIGS. 3, 5, 6A, 6B and 7B, the sliding closure member includes a main body portion 64 having a middle connector portion 66, an upper arm 70 extending in the occlusal direction typically approximately at a right angle from a labial end 72 of the middle connector portion, an upper cover portion 74 extending in the gingival direction typically approximately at a right angle from a labial end of the middle connector portion, and a lower arm 76 extending in the occlusal direction typically approximately at a right angle from a lingual end 78 of the middle connector portion.

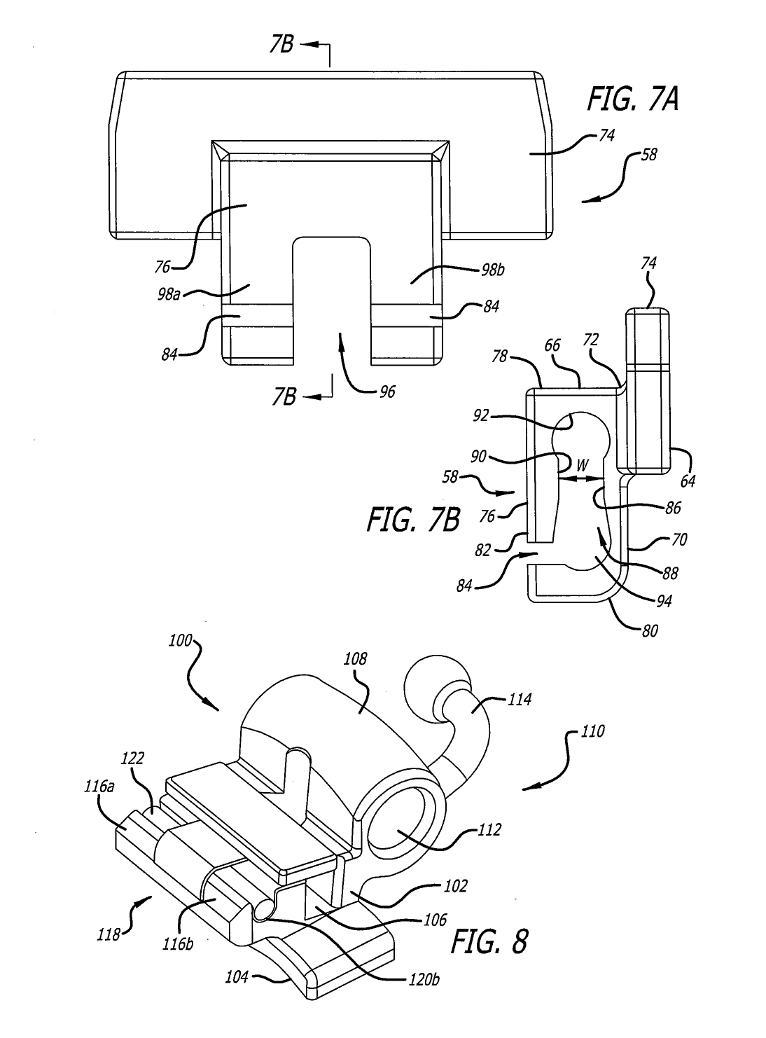

The main body portion has a configuration allowing at least one of the upper and lower arms to flex with respect to the other and the middle connector portion, such that the shape of the interior slot can change as the sliding closure member is moved from one position to another, to reversibly latch the sliding closure member as desired. Referring to FIG. 7B, in this embodiment the occlusal end 80 of the upper arm extends in the lingual direction approximately at a right angle from the main portion of the upper arm, and is spaced apart from the occlusal end 82 of the lower arm to form a narrow slit 84 adjacent to the occlusal end of the lower arm. The upper arm and lower arm have interior surfaces 86 defining an interior slot 88 configured to receive the mounting pin, thus forming an integral part of the latching mechanism in cooperation with the mounting pin. The interior slot has a generally double-ended keyhole shape, with a middle narrow neck portion 90 with a width W slightly smaller than the diameter D of the mounting pin, a generally larger rounded gingival end portion 92 adjacent to the middle connector portion, and a generally larger rounded occlusal end portion 94 adjacent to and connecting with the slit. Alternatively, a slit may be formed in a desired location along the lower arm, to allow at least one of the upper and lower arms to flex with respect to the other and the middle connector portion, or the sliding closure member may be formed without a slit, and of a material of sufficient flexibility and with at least one of the upper and lower arms being dimensioned of an appropriate thickness such that at least one the upper and lower arms can flex with respect to the other and the middle connector portion.

As is illustrated in FIGS. 3 and 6A-7B, in this embodiment the lower arm of the sliding closure member includes a generally rectangular middle cutout or notch portion 96 between first and second portions 98a and 98b of the lower arm of the sliding closure member, with the generally rectangular middle cutout or notch portion opening into the slit of the sliding closure member, allowing the lower arm of the sliding closure member to rotate over the generally rectangular middle post portion and allowing the first and second portions of the lower arm of the sliding closure member to rotate into the open spaces defined by the recesses on either side of the middle post portion when the sliding closure member is in the open position, to rotate the upper cover portion of the sliding closure member away from the archwire slot to permit easy access to the archwire slot. The sliding closure member can be made of a material such as plastic, polymer, metal, metal alloy, ceramic, or composite, or the like.

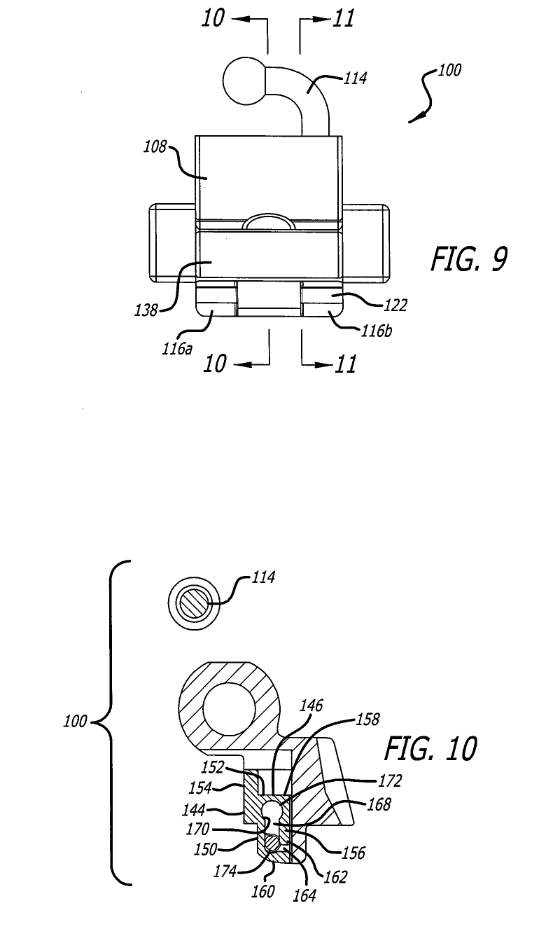

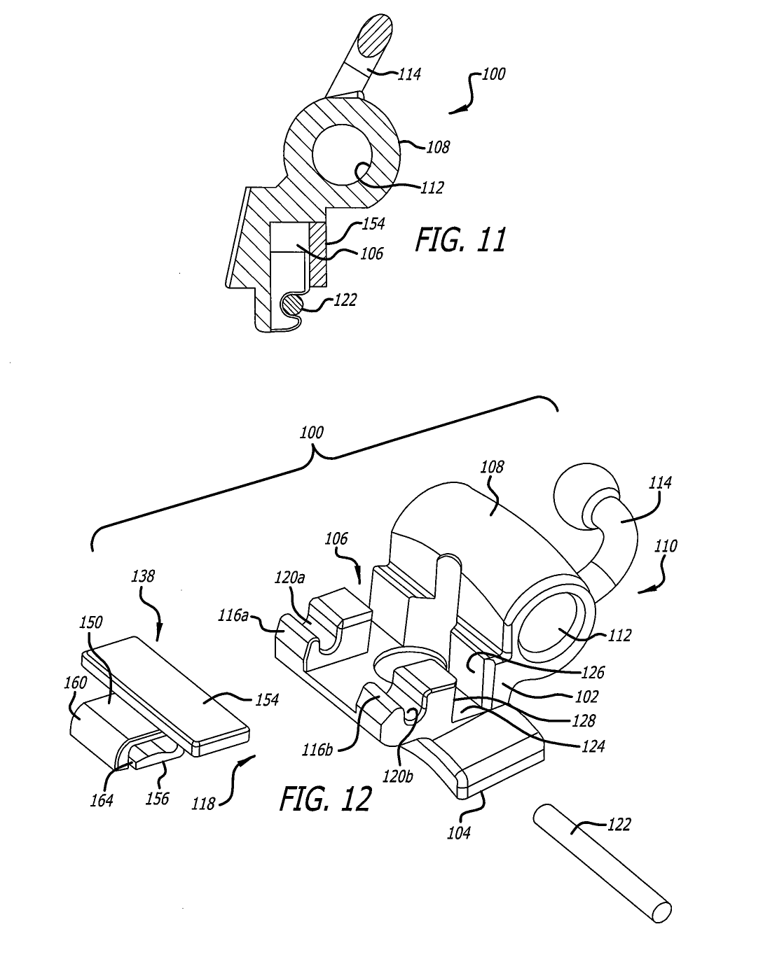

Referring to FIGS. 8-14, in a second embodiment of the present invention, the self-ligating orthodontic bracket is implemented in a molar buccal tube bracket 100 having a unitary body 102 including a base 104 defined on a bottom side configured to be joined to an orthodontic band or configured to be adhered to a tooth surface (not shown). This type of bracket is typically used on the molar teeth (1st molar, and 2nd molar) for straightening and alignment. The bonding base is currently preferably formed to have a bottom rectangular grid forming a plurality of rectangular pockets. The unitary body can be formed of metal, metal alloy, plastic, polymer, composite, or ceramic, for example, although other similar materials may also be suitable. The bracket body also is also preferably formed to include an archwire slot 106 that is configured to receive an archwire (not shown), for anchorage and straightening of the tooth.

The bracket body optionally may also include an auxiliary tube 108 on the gingival side 110 of the body, with an aperture 112 for receiving wires (not shown) to assist in anchorage and straightening of the tooth along with the archwire. The bracket body optionally may also include a hook 114 on the gingival side of the tube. A pair of spaced apart mounting arms 116a, 116b are formed on the occlusal 118 mesial and distal sides of the bracket body, including first and second slots 120a, 120b, in which a mounting pin 122, typically having a substantially cylindrical uniform, constant diameter along the length of the mounting pin, is permanently mounted. While the mounting pin is typically substantially cylindrical, the mounting pin may alternatively have a varying or non-constant diameter, such as a stepped cylindrical configuration or a tapered configuration, although configurations with a squared, rectangular, triangular, or other similar cross-sectional configurations, for example, may also be suitable, with the first and second slots having corresponding shapes. Referring to FIG. 12, the archwire slot is typically recessed from the mounting arms, and includes a labial planar surface forming a base wall 124 opposing the bonding base, and extending between the mounting arms, a gingival side wall 126, and an occlusal side wall 128.

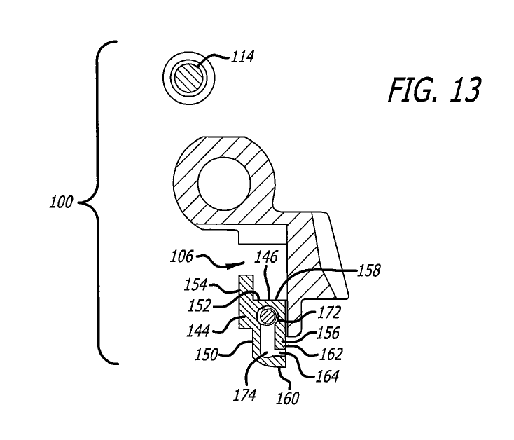

A sliding closure member 138 is slidably and rotatably mounted to the body of the bracket, and is slidably movable in the occlusal/gingival direction between a closed position covering the archwire slot, as shown in FIGS. 8-10, and an open position in which the archwire slot is uncovered, as shown in FIG. 13, to permit easy access to the archwire slot. The sliding closure member can be reversibly latched in at least one of the open and closed positions with a reversibly latching mechanism, which will be described below. Referring to FIGS. 8, 10 and 13, the sliding closure member includes a main body portion 144 having a middle connector portion 146 at a gingival end of the main body portion, an upper arm 150 extending in the occlusal direction typically approximately at a right angle from a labial end 152 of the middle connector portion, an upper cover portion 154 extending in the gingival direction typically approximately at a right angle from a labial side of the middle connector portion, and a lower arm 156 extending the occlusal direction typically approximately at a right angle from a lingual side 158 of the middle connector portion. The occlusal end 160 of the upper arm extends in the lingual direction typically approximately at a right angle from the upper arm, and is spaced apart from the occlusal end 162 of the lower arm to form a narrow slit 164 adjacent to the occlusal end of the lower arm. The upper arm and lower arm have interior surfaces defining an interior slot 168 configured to receive the mounting pin, thus forming an integral part of the latching mechanism in cooperation with the mounting pin. The interior slot has a generally double-ended keyhole shape, with a middle narrow neck portion 170 with a width slightly smaller than the diameter of the mounting pin, a generally rounded gingival end portion 172 adjacent to the middle connector portion, and a generally rounded occlusal end portion 174 adjacent to and connecting with the slit. Alternatively, a slit may be formed in a desired location along the lower arm, to allow at least one of the upper and lower arms to flex with respect to the other and the middle connector portion, or the sliding closure member may be formed without a slit, and of a material of sufficient flexibility and with at least one of the upper and lower arms being dimensioned of an appropriate thickness such that at least one the upper and lower arms can flex with respect to the other and the middle connector portion.

It will be appreciated that the sliding closure member has a configuration allowing at least one of the upper and lower arms to flex with respect to the other and the middle connector portion, such that the shape of the interior slot can change as the sliding closure member is moved from one position to another, to reversibly latch the sliding closure member in cooperation with the mounting pin as desired. When provided the slit provided in the sliding closure member also allows at least one of the upper and lower arms of the sliding closure member to flex to an extent with respect to the other and the middle connector portion that allows for the sliding closure member to be removed and replaced with either the same or different types of sliding closure members, as needed. In one form of the sliding closure member, the inner slot may have the shape described above, with two large rounded ends substantially equally sized and shaped, with a narrowed portion in the middle of the slot, allowing the bracket to serve as a passive self-ligating bracket. When assembled to the bracket, and the sliding closure member is in the open position, the pin is in a large end of the double-ended keyhole shaped slot toward the front of the sliding closure member. Because the narrow portion of the double-ended keyhole slot is too small for the pin to passively fit through, the sliding closure member is held in the open position. When force is applied to the sliding closure member and it is moved to the closed position, the sliding closure member flexes slightly, and the pin squeezes through the narrow part of the double-ended keyhole slot and pops into the large portion of the double-ended keyhole slot near the back of the sliding closure member, the sliding closure member un-flexes and is now held in the closed position. However, as is further explained below, if desired, a different form of the sliding closure member with a differently shaped inner slot may be substituted, to allow the bracket to serve as an active self-ligating bracket, as may be needed at different stages of treatment. It should be appreciated that the interior slot defined between the upper and lower arms of the sliding closure member may have a variety of shapes. For example, the interior slot may have a narrowed middle portion may be connected between two larger ends, with one or both of the larger ends having a squared or rectangular shape, a squared or rectangular shape with rounded corners, an L-shape, or an inverted heart shape having a broad side connected to the narrowed middle portion, and other similar shapes may also be suitable.

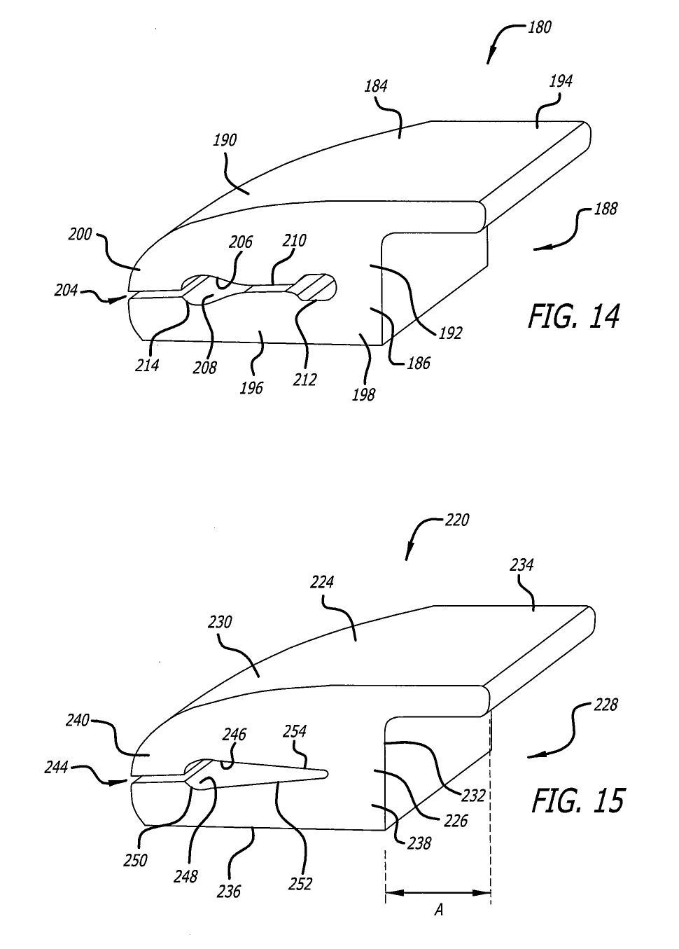

Referring to FIG. 14, in a first variation of the sliding closure members of the first and second embodiments that may be substituted for the sliding closure members of the first and second embodiments, the sliding closure member 180 includes a main body portion 184 having a middle connector portion 186 at a gingival end 188 of the main body portion, an upper arm 190 extending in the occlusal direction approximately at a right angle from a labial side 192 of the middle connector portion, an upper cover portion 194 extending in the gingival direction approximately at a right angle from a labial side of the middle connector portion, and a lower arm 196 extending in the occlusal direction approximately at a right angle from a lingual side 198 of the middle connector portion.

The occlusal end 200 of the upper arm includes a narrow occlusal slit 204, allowing the upper and lower arms to flex slightly with respect to the middle connector portion. The upper arm and lower arm have interior surfaces 206 defining a generally double-ended keyhole slot 208 having a middle narrow neck portion 210 with a width slightly smaller than the diameter of the mounting pin, a generally larger rounded gingival end portion 212 adjacent to the middle connector portion, and a generally larger rounded occlusal end portion 214 adjacent to and connecting with the narrow occlusal slit.

Referring to FIG. 15, in a second variation of the sliding closure members of the first and second embodiments that may be substituted for the sliding closure members of the first and second embodiments, the shape of the large portion of the keyhole slot near the gingival side of the closure member is formed to resemble a teardrop. The sliding closure member 220 includes a main body portion 224 having a middle connector portion 226 at a gingival end 228 of the main body portion, an upper arm 230 extending in the occlusal direction approximately at a right angle from a labial side 232 of the middle connector portion, an upper cover portion 234 extending in the gingival direction approximately at a right angle from a labial side of the middle connector portion, and a lower arm 236 extending in the occlusal direction approximately at a right angle from a lingual side 238 of the middle connector portion.

The occlusal end 240 of the upper arm includes a narrow occlusal slit 244, allowing the upper and lower arms to flex slightly with respect to the middle connector portion. The upper arm and lower arm have interior surfaces 246 defining a generally teardrop shaped keyhole slot 248 having a wider generally rounded occlusal end portion 250 wider than the diameter of the mounting pin adjacent to and connecting with the narrow occlusal slit tapering smoothly to a narrow neck portion 252 with a narrower generally rounded gingival end 254 with a width slightly smaller than the diameter of the mounting pin adjacent to the middle connector portion.

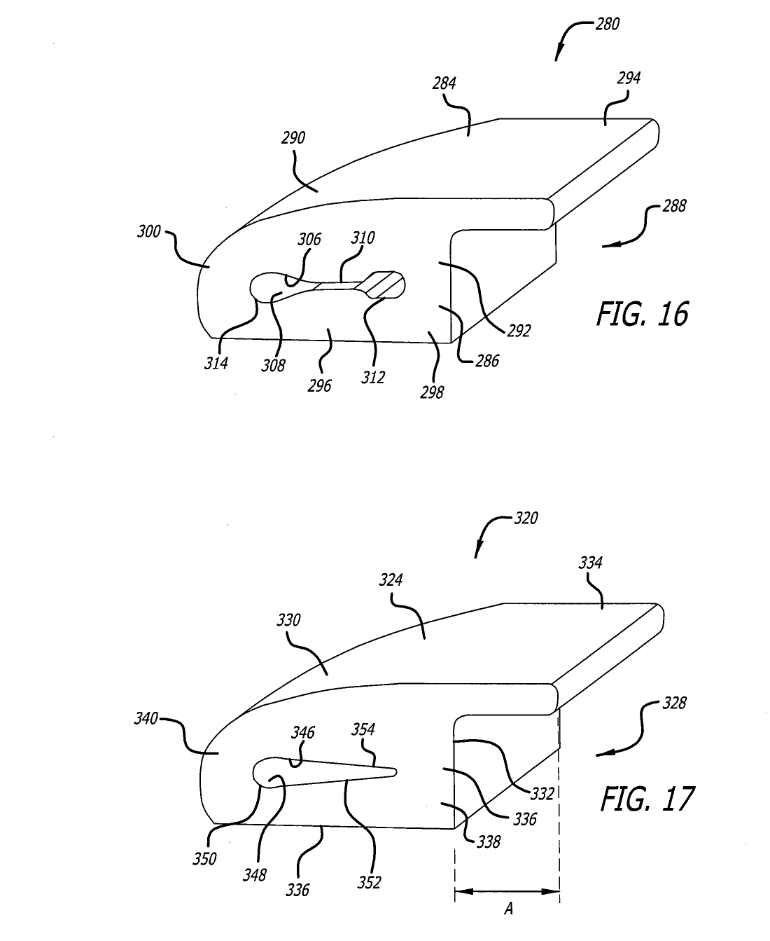

Referring to FIG. 16, in a third variation of the sliding closure members of the first and second embodiments that may be substituted for the sliding closure members of the first and second embodiments, the sliding closure member 280 includes a main body portion 284 having a middle connector portion 286 at a gingival end 288 of the main body portion, an upper arm 290 extending in the occlusal direction approximately at a right angle from a labial side 292 of the middle connector portion, an upper cover portion 294 extending in the gingival direction approximately at a right angle from a labial side of the middle connector portion, and a lower arm 296 extending in the occlusal direction approximately at a right angle from a lingual side 298 of the middle connector portion.

In this variation of the sliding closure member, no slit is formed in the occlusal end or along the upper arm or lower arm, but the upper and lower arms of the sliding closure member are formed of a material of sufficient flexibility and with at least one of the upper and lower arms being dimensioned of an appropriate thickness to allow at least one the upper and lower arms to flex at least slightly with respect to the other and the middle connector portion. The upper and lower arms of the sliding closure member can be made of a material such as plastic, polymer, metal, metal alloy, ceramic, or composite, for example, although other similar materials may also be suitable. The upper arm and lower arm have interior surfaces 306 defining a generally double-ended keyhole slot 308 having a middle narrow neck portion 310 with a width slightly smaller than the diameter of the mounting pin, a generally larger rounded gingival end portion 312 adjacent to the middle connector portion, and a generally larger rounded occlusal end portion 314. Alternatively, the interior slot defined between the upper and lower arms of the sliding closure member may have a variety of shapes, such as a narrowed middle portion two larger ends wherein one or both of the larger ends have a squared or rectangular shape, a squared or rectangular shape with rounded corners, an L-shape, or an inverted heart shape having a broad side connected to the narrowed middle portion, although other similar shapes may also be suitable.

Referring to FIG. 17, in a fourth variation of the sliding closure members of the first and second embodiments that may be substituted for the sliding closure members of the first and second embodiments, the shape of the large portion of the keyhole slot near the gingival side of the closure member is formed to resemble a teardrop, and no slit is formed in the occlusal end or along the upper arm or lower arm. However, the upper and lower arms of the sliding closure member are formed of a material of sufficient flexibility and with at least one of the upper and lower arms being dimensioned of an appropriate thickness to allow at least one the upper and lower arms to flex at least slightly with respect to the other and the middle connector portion. The upper and lower arms of the sliding closure member can be made of a material such as plastic, polymer, metal, metal alloy, ceramic, or composite, for example, although other similar materials may also be suitable. The sliding closure member 320 includes a main body portion 324 having a middle connector portion 326 at a gingival end 328 of the main body portion, an upper arm 330 extending in the occlusal direction approximately at a right angle from a labial side 332 of the middle connector portion, an upper cover portion 334 extending in the gingival direction approximately at a right angle from a labial side of the middle connector portion, and a lower arm 336 extending in the occlusal direction approximately at a right angle from a lingual side 338 of the middle connector portion.

The upper arm and lower arm have interior surfaces 346 defining a generally teardrop shaped keyhole slot 348 having a wider generally rounded occlusal end portion 350 wider than the diameter of the mounting pin tapering smoothly to a narrow neck portion 352 with a narrower generally rounded gingival end 354 with a width slightly smaller than the diameter of the mounting pin adjacent to the middle connector portion.

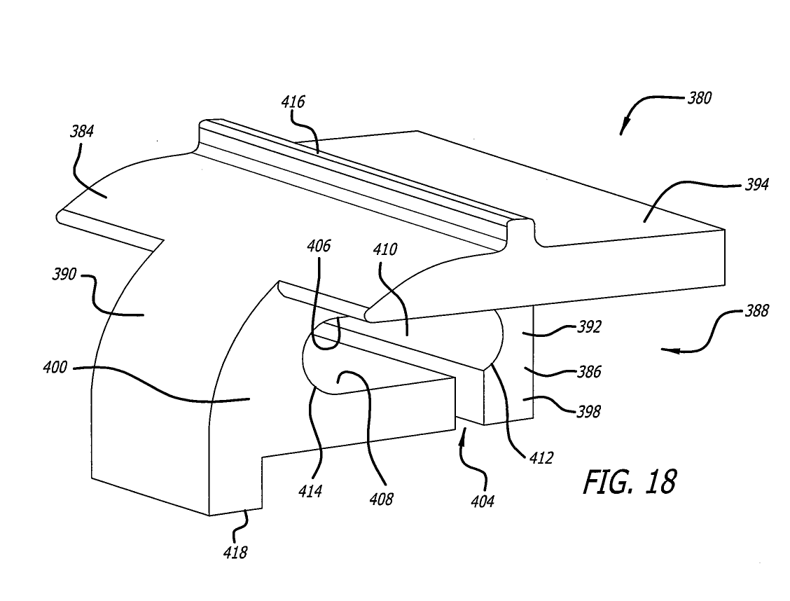

Referring to FIG. 18, in a fifth variation of the sliding closure members of the first and second embodiments that may be substituted for the sliding closure members of the first and second embodiments, the sliding closure member 380 includes a main body portion 384 having a middle connector portion 386 at a gingival end 388 of the main body portion, an upper arm 390 extending in the occlusal direction approximately at a right angle from a labial side 392 of the middle connector portion, an upper cover portion 394 extending in the gingival direction approximately at a right angle from a labial side of the middle connector portion, and a lower arm 396 extending in the occlusal direction approximately at a right angle from a lingual side 398 of the middle connector portion.

A narrow slit 404 is formed in the lower arm adjacent to the gingival end 400 of the lower arm and adjacent to the middle connector portion, allowing the upper and lower arms to flex slightly with respect to each other and the middle connector portion. The upper arm and lower arm have interior surfaces 406 defining a generally double-ended keyhole slot 408 having a middle narrow neck portion 410 with a width slightly smaller than the diameter of the mounting pin, a generally larger rounded gingival end portion 412 adjacent to the middle connector portion connecting with the narrow slit, and a generally larger rounded occlusal end portion 414. A ridge or tab 416 may also be formed on the external surface of the upper cover portion allowing a user to more easily grip and move the sliding closure member between open and closed positions, and an extension or lip 418 may be included at the occlusal end 420 of the lower arm, to stabilize the closure member while in the closed position, and to further shield the assembly of the sliding closure member and bracket from exposure to plaque, food, bacteria, and the like.

As will be apparent, while the sliding closure member is in a closed position, the mounting pin will always be in contact with the inner surface of the sliding closure member such that the sliding closure member constantly will be biased to be in the closed position with at least one side wall biased to press in a direction toward an opposing side wall against an archwire in the archwire slot, and will never be passively contained in a space larger than the pin.

In view of the forms that the interior slot of the sliding closure member can take, the position of the sliding closure member can be variable, and the sliding closure member can be under constant closing pressure as desired, allowing the self-ligating bracket to be made into an active self-ligating bracket, with the sliding closure member applying pressure to an archwire in the archwire slot to bias the archwire against the surface of the archwire slot. With active self-ligating brackets it is typically desirable to have no pressure on the wire early in treatment when smaller wires are used, and for the bracket to be active to apply pressure later in treatment when larger wires are to be used. The self-ligating bracket of the present invention provides a sliding closure member that forms at least one of the walls of the archwire slot that moves when the sliding closure member moves, so that the width of the archwire slot can be varied. The bracket can be made active by narrowing the slot to the point that the archwire is in contact with both vertical slot walls and actively sandwiched between them. The archwire would thus be pressed into a coplanar relationship with the two largest surfaces of the slot. Referring to FIG. 15, by building the sliding closure member with a dimension “A” smaller than a particular archwire width, the sliding closure member can close to an extent that the archwire is pinched between the wall provided by the sliding closure member and the opposing wall of the slot. Although a gap may exist between the slot wall and the edge of cover of the sliding closure member, the archwire will not escape the slot, because the wire would be much bigger than the gap, and the gap would also be under constant closing pressure. For archwires with sections smaller than dimension “A” the sliding closure member would close completely, and leaving no gap between the cover of the sliding closure member and the slot, and providing no compression of the archwire by the archwire slot. The sliding closure member can be configured to cover only a portion of the archwire slot or the entire archwire slot in both the mesial/distal and occlusal/gingival directions.

It will also be apparent from the foregoing that while particular forms of the invention have been illustrated and described, various modifications can be made without departing from the spirit and scope of the invention. Accordingly, it is not intended that the invention be limited, except as by the appended claims.

1. A self-ligating orthodontic bracket including a bracket body having a bottom side, a top side, an occlusal side, a gingival side, a mesial side and a distal side, the bracket body including a base defined on a bottom side thereof configured to be joined to an orthodontic band or configured to be adhered to a tooth surface, the self-ligating orthodontic bracket comprising:
an archwire slot defined in the top side of the bracket body, the archwire slot being configured to receive an archwire;
a pair of spaced apart mounting arms on the occlusal mesial and distal sides of the body, each of said mounting arms including first and second mounting slots;
a mounting pin permanently mounted in said first and second mounting slots of said mounting arms;
a sliding closure member slidably mounted to the body of the bracket, the sliding closure member being slidably movable occlusally and gingivally between a closed position and an open position, the archwire slot being covered when the sliding closure member is in the closed position, and the archwire slot in being uncovered when the sliding closure member is in the open position, the sliding closure member including a main body portion having a middle connector portion at a gingival end of the main body portion, an upper arm extending in the occlusal direction from the middle connector portion, an upper cover portion extending in the gingival direction from the middle connector portion, and a lower arm extending in the occlusal direction from the middle connector portion, the upper arm and lower arm having occlusal and gingival ends and interior surfaces defining a slot therebetween, at least a portion of said slot having a width slightly smaller than a diameter of the mounting pin and at least a portion having a width larger than the diameter of the mounting pin, said slot being configured to bias said sliding closure member to reversibly latch in cooperation with said mounting pin in at least one of said open and closed positions.

2. The self-ligating orthodontic bracket of claim 1, wherein at least one of said upper and lower arms is configured to flex relative to the other of said upper and lower arms and said middle connector portion.

3. The self-ligating orthodontic bracket of claim 2, further comprising a slit defined in said sliding closure member configured to permit at least one of said upper and lower arms to flex relative to the other of said upper and lower arms and said middle connector portion.

4. The self-ligating orthodontic bracket of claim 1, wherein said bracket body comprises a plurality of tiewings.

5. The self-ligating orthodontic bracket of claim 1, wherein said bracket body comprises a pair of spaced apart tiewings on the gingival mesial and distal sides of the body, and the archwire slot includes a planar surface forming a base wall opposing the bonding base and extending between the spaced apart tie wings and mounting arms, a gingival side wall, and an occlusal side wall, the archwire slot being recessed from the tiewings.

6. The self-ligating orthodontic bracket of claim 1, wherein said bracket body comprises a middle post portion positioned between and spaced apart from the mounting arms, with a planar surface forming an extension of the base wall of the archwire slot between first and second openings defined in the body by first and second recesses on either side of the middle post portion.

7. The self-ligating orthodontic bracket of claim 6, wherein said lower arm of the sliding closure member includes a generally rectangular middle notch portion between first and second portions of the lower arm of the sliding closure member, with the generally rectangular middle notch portion opening into the slit of the sliding closure member, allowing the lower arm of the sliding closure member to rotate over the middle post portion and allowing the first and second portions of the lower arm of the sliding closure member to rotate into said openings defined by the recesses on either side of the middle post portion when the sliding closure member is in the open position, to rotate the upper cover portion of the sliding closure member away from the archwire slot.

8. The self-ligating orthodontic bracket of claim 1, wherein said archwire slot is recessed from the mounting arms.

9. The self-ligating orthodontic bracket of claim 1, wherein said sliding closure member is slidably and rotatably mounted to the body of the bracket.

10. The self-ligating orthodontic bracket of claim 3, wherein said upper arm has a main portion that extends in the occlusal direction approximately at a right angle from the middle connector portion, said lower arm extends in the occlusal direction approximately at a right angle from the middle connector portion, and the occlusal end of the upper arm extends approximately at a right angle from the main portion of the upper arm, and is spaced apart from the occlusal end of the lower arm to form said slit.

11. The self-ligating orthodontic bracket of claim 2, wherein said upper arm and lower arm have interior surfaces defining a generally double-ended keyhole slot having a middle narrow neck portion with a width slightly smaller than a diameter of the mounting pin, a generally rounded gingival end portion adjacent to the middle connector portion having a width larger than a diameter of the mounting pin, and a generally rounded occlusal end portion having a width larger than a diameter of the mounting pin.

12. The self-ligating orthodontic bracket of claim 3, wherein said upper arm and lower arm have interior surfaces defining a generally double-ended keyhole slot having a middle narrow neck portion with a width slightly smaller than a diameter of the mounting pin, a generally rounded gingival end portion adjacent to the middle connector portion having a width larger than a diameter of the mounting pin, and a generally rounded occlusal end portion having a width larger than a diameter of the mounting pin, at least one of said generally rounded gingival end portion and said generally rounded occlusal portion being adjacent to and connecting with the slit.

13. The self-ligating orthodontic bracket of claim 1, wherein said upper arm and lower arm have interior surfaces defining a generally teardrop shaped keyhole slot having a generally rounded occlusal end portion wider than a diameter of the mounting pin, said generally rounded occlusal end portion tapering smoothly to a narrow neck portion and a narrower generally rounded gingival end portion with a width slightly smaller than a diameter of the mounting pin.

14. The self-ligating orthodontic bracket of claim 3, wherein said upper arm and lower arm have interior surfaces defining a generally teardrop shaped keyhole slot having a generally rounded occlusal end portion wider than a diameter of the mounting pin adjacent to and connecting with said slit, said generally rounded occlusal end portion tapering smoothly to a narrow neck portion and a narrower generally rounded gingival end portion with a width slightly smaller than a diameter of the mounting pin.

15. The self-ligating orthodontic bracket of claim 1, wherein said bracket is an active self-ligating bracket.

16. The self-ligating orthodontic bracket of claim 1, wherein said bracket comprises a molar buccal tube bracket.

17. The self-ligating orthodontic bracket of claim 16, further comprising an auxiliary tube connected to said bracket body, said auxiliary tube having an aperture configured to receive a wire, wherein said archwire slot is recessed from said auxiliary tube and said mounting arms, and said archwire slot includes a gingival side wall, and an occlusal side wall, and a planar surface forming a base wall opposing the bonding base and extending between said auxiliary tube and said mounting arms.

18. The self-ligating orthodontic bracket of claim 17, further comprising a hook mounted to said auxiliary tube.

19. A self-ligating orthodontic bracket including a bracket body having a bottom side, a top side, an occlusal side, a gingival side, a mesial side and a distal side, the bracket body including a base defined on a bottom side thereof configured to be joined to an orthodontic band or configured to be adhered to a tooth surface, the self-ligating orthodontic bracket comprising:
an archwire slot defined in the top side of the bracket body, the archwire slot being configured to receive an archwire;
a pair of spaced apart mounting arms on the occlusal mesial and distal sides of the body, each of said mounting arms including first and second mounting slots;
a mounting pin permanently mounted in said first and second mounting slots of said mounting arms;
a sliding closure member slidably and rotatably mounted to the body of the bracket, the sliding closure member being slidably movable occlusally and gingivally between a closed position and an open position, the archwire slot being covered when the sliding closure member is in the closed position, and the archwire slot in being uncovered when the sliding closure member is in the open position, the sliding closure member including a main body portion having a middle connector portion at a gingival end of the main body portion, an upper arm extending in the occlusal direction from the middle connector portion, an upper cover portion extending in the gingival direction from the middle connector portion, and a lower arm extending in the occlusal direction from the middle connector portion, the upper arm and lower arm having occlusal and gingival ends and interior surfaces defining a slot therebetween, at least a portion of said slot having a width slightly smaller than a diameter of the mounting pin and at least a portion having a width larger than the diameter of the mounting pin, at least one of said upper and lower arms being configured to flex relative to the other of said upper and lower arms and said middle connector portion to bias said sliding closure member to reversibly latch in cooperation with said mounting pin in each of said open and closed positions.

20. The self-ligating orthodontic bracket of claim 19, further comprising a slit defined in said sliding closure member configured to permit at least one of said upper and lower arms to flex relative to the other of said upper and lower arms and said middle connector portion.

21. The self-ligating orthodontic bracket of claim 19, wherein said bracket body comprises a middle post portion positioned between and spaced apart from the mounting arms, with a planar surface forming an extension of the base wall of the archwire slot between first and second openings defined in the body by first and second recesses on either side of the middle post portion, and said lower arm of the sliding closure member includes a generally rectangular middle notch portion between first and second portions of the lower arm of the sliding closure member, with the generally rectangular middle notch portion opening into the slit of the sliding closure member, allowing the lower arm of the sliding closure member to rotate over the middle post portion and allowing the first and second portions of the lower arm of the sliding closure member to rotate into said openings defined by the recesses on either side of the middle post portion when the sliding closure member is in the open position, to rotate the upper cover portion of the sliding closure member away from the archwire slot.

22. The self-ligating orthodontic bracket of claim 19, wherein said upper arm and lower arm have interior surfaces defining a generally double-ended keyhole slot having a middle narrow neck portion with a width slightly smaller than a diameter of the mounting pin, a generally rounded gingival end portion adjacent to the middle connector portion having a width larger than a diameter of the mounting pin, and a generally rounded occlusal end portion having a width larger than a diameter of the mounting pin.

23. The self-ligating orthodontic bracket of claim 20, wherein said upper arm and lower arm have interior surfaces defining a generally double-ended keyhole slot having a middle narrow neck portion with a width slightly smaller than a diameter of the mounting pin, a generally rounded gingival end portion adjacent to the middle connector portion having a width larger than a diameter of the mounting pin, and a generally rounded occlusal end portion having a width larger than a diameter of the mounting pin, at least one of said generally rounded gingival end portion and said generally rounded occlusal portion being adjacent to and connecting with the slit.

24. The self-ligating orthodontic bracket of claim 19, wherein said upper arm and lower arm have interior surfaces defining a generally teardrop shaped keyhole slot having a generally rounded occlusal end portion wider than a diameter of the mounting pin, said generally rounded occlusal end portion tapering smoothly to a narrow neck portion and a narrower generally rounded gingival end portion with a width slightly smaller than a diameter of the mounting pin.

25. The self-ligating orthodontic bracket of claim 20, wherein said upper arm and lower arm have interior surfaces defining a generally teardrop shaped keyhole slot having a generally rounded occlusal end portion wider than a diameter of the mounting pin adjacent to and connecting with said slit, said generally rounded occlusal end portion tapering smoothly to a narrow neck portion and a narrower generally rounded gingival end portion with a width slightly smaller than a diameter of the mounting pin.

26. The self-ligating orthodontic bracket of claim 19, further comprising an auxiliary tube connected to said bracket body, said auxiliary tube having an aperture configured to receive a wire, wherein said archwire slot is recessed from said auxiliary tube and said mounting arms, and said archwire slot includes a gingival side wall, and an occlusal side wall, and a planar surface forming a base wall opposing the base and extending between said auxiliary tube and said mounting arms.

27. The self-ligating orthodontic bracket of claim 19, further comprising a hook connected to said bracket body.

28. A self-ligating orthodontic bracket including a bracket body having a bottom side, a top side, an occlusal side, a gingival side, a mesial side and a distal side, the bracket body including a base defined on a bottom side thereof configured to be joined to an orthodontic band or configured to be adhered to a tooth surface, the self-ligating orthodontic bracket comprising:
an archwire slot defined in the top side of the bracket body, the archwire slot being configured to receive an archwire;
a pair of spaced apart mounting arms on the occlusal mesial and distal sides of the body, each of said mounting arms including first and second mounting slots;
a mounting pin permanently mounted in said first and second mounting slots of said mounting arms;
a closure member movably mounted to the body of the bracket and forming two walls of said archwire slot, said closure member being configured to cooperate with said mounting pin to bias at least one of said two walls in a direction toward an opposing side wall so as to receive and retain an archwire received in the archwire slot, the closure member being movable occlusally and gingivally between a closed position and an open position, the archwire slot being covered when the closure member is in the closed position, and the archwire slot in being uncovered when the closure member is in the open position, the closure member including a main body portion having a middle connector portion at a gingival end of the main body portion, an upper arm extending in the occlusal direction from the middle connector portion, an upper cover portion extending in the gingival direction from the middle connector portion, and a lower arm extending in the occlusal direction from the middle connector portion, the upper arm and lower arm having occlusal and gingival ends and interior surfaces defining a slot therebetween, at least a portion of said slot having a width slightly smaller than a diameter of the mounting pin and at least a portion having a width larger than the diameter of the mounting pin, said slot being configured to bias said closure member to reversibly latch in cooperation with said mounting pin in at least one of said open and closed positions.

29. The self-ligating orthodontic bracket of claim 28, wherein said closure member is slidably mounted to the body of the bracket.

30. The self-ligating orthodontic bracket of claim 29, wherein said upper cover portion of said closure member provides one of said two side walls of said archwire slot, and said middle connector portion of said closure member provides the other of said two side walls of said archwire slot, said two side walls extending in substantially orthogonal directions to allow containment of an archwire received in the archwire slot from said two substantially orthogonal directions, and whereby said archwire slot has a width that is variable.

31. The self-ligating orthodontic bracket of claim 28, wherein at least one of said upper and lower arms is configured to flex relative to the other of said upper and lower arms and said middle connector portion.

32. The self-ligating orthodontic bracket of claim 30, further comprising a slit defined in said closure member configured to permit at least one of said upper and lower arms to flex relative to the other of said upper and lower arms and said middle connector portion.

33. The self-ligating orthodontic bracket of claim 31, wherein said bracket body comprises a middle post portion positioned between and spaced apart from the mounting arms, with a planar surface forming an extension of the base wall of the archwire slot between first and second openings defined in the body by first and second recesses on either side of the middle post portion, and wherein said lower arm of the closure member includes a generally rectangular middle notch portion between first and second portions of the lower arm of the closure member, with the generally rectangular middle notch portion opening into the slit of the closure member, allowing the lower arm of the closure member to rotate over the middle post portion and allowing the first and second portions of the lower arm of the closure member to rotate into said openings defined by the recesses on either side of the middle post portion when the closure member is in the open position, to rotate the upper cover portion of the closure member away from the archwire slot.

34. The self-ligating orthodontic bracket of claim 28, wherein said closure member is slidably and rotatably mounted to the body of the bracket.

35. The self-ligating orthodontic bracket of claim 28, wherein said upper arm and lower arm have interior surfaces defining a generally double-ended keyhole slot having a middle narrow neck portion with a width slightly smaller than a diameter of the mounting pin, a generally rounded gingival end portion adjacent to the middle connector portion having a width larger than a diameter of the mounting pin, and a generally rounded occlusal end portion having a width larger than a diameter of the mounting pin.

36. The self-ligating orthodontic bracket of claim 32, wherein said upper arm and lower arm have interior surfaces defining a generally double-ended keyhole slot having a middle narrow neck portion with a width slightly smaller than a diameter of the mounting pin, a generally rounded gingival end portion adjacent to the middle connector portion having a width larger than a diameter of the mounting pin, and a generally rounded occlusal end portion having a width larger than a diameter of the mounting pin, at least one of said generally rounded gingival end portion and said generally rounded occlusal portion being adjacent to and connecting with the slit.

37. The self-ligating orthodontic bracket of claim 28, wherein said upper arm and lower arm have interior surfaces defining a generally teardrop shaped keyhole slot having a generally rounded occlusal end portion wider than a diameter of the mounting pin, said generally rounded occlusal end portion tapering smoothly to a narrow neck portion and a narrower generally rounded gingival end portion with a width slightly smaller than a diameter of the mounting pin.

38. The self-ligating orthodontic bracket of claim 32, wherein said upper arm and lower arm have interior surfaces defining a generally teardrop shaped keyhole slot having a generally rounded occlusal end portion wider than a diameter of the mounting pin adjacent to and connecting with said slit, said generally rounded occlusal end portion tapering smoothly to a narrow neck portion and a narrower generally rounded gingival end portion with a width slightly smaller than a diameter of the mounting pin.

39. The self-ligating orthodontic bracket of claim 28, wherein said bracket is an active self-ligating bracket.
